(19) United States
(12) Patent Application Publication
(10) Pub. No.: US 2023/0202475 A1
(43) Pub. Date: Jun. 29, 2023

(54) DRIVING ASSISTANCE APPARATUS, DRIVING ASSISTANCE METHOD, AND PROGRAM

(71) Applicants: TOYOTA JIDOSHA KABUSHIKI KAISHA, Toyota-shi (JP); DENSO CORPORATION, Kariya-shi (JP)

(72) Inventors: Koichi TSUCHIYA, Susono-shi (JP); Katsuhiro KOIKE, Tokyo (JP)

(73) Assignees: TOYOTA JIDOSHA KABUSHIKI KAISHA, Toyota-shi (JP); DENSO CORPORATION, Kariya-shi (JP)

(21) Appl. No.: 17/981,749

(22) Filed: Nov. 7, 2022

(30) Foreign Application Priority Data
Dec. 24, 2021 (JP) 2021-210292

(51) Int. Cl. B60W 30/14; B60W 30/09; B60W 30/095; B60W 30/16; B60W 40/04; B60W 10/18

(52) U.S. Cl. CPC B60W 30/146; B60W 30/09; B60W 30/0956; B60W 30/16; B60W 40/04; B60W 10/18; B60W 2540/106; B60W 2554/80

(57) ABSTRACT

Disclosed is a driving assistance apparatus which includes an object information obtaining section for obtaining a piece of information regarding an object present ahead of a vehicle, an operation amount obtaining section for obtaining an accelerator pedal operation amount, and a control section. The control section predicts whether or not the vehicle will collide with the object on the basis of the obtained object information and executes collision avoidance assistance control for decelerating the vehicle at a predetermined demanded deceleration rate in the case where the control section predicts that the vehicle will collide with the object and an execution condition becomes satisfied as a result of the obtained accelerator pedal operation amount having become equal to or greater than a predetermined operation amount. The control section sets the demanded deceleration rate on the basis of the distance and the relative speed obtained when the execution condition becomes satisfied.

### BACKGROUND OF THE INVENTION

### Field of the Invention

The present disclosure relates to a driving assistance apparatus, a driving assistance method, and a program.

### Description of the Related Art

Conventionally, there has been known an apparatus which performs collision avoidance assistance control when the apparatus detects an obstacle which is present ahead of an own vehicle during a travel and the own vehicle is highly likely to collide with the obstacle (see, for example, Japanese Patent Application Laid-Open (kokai) No. 2019-026129). In the collision avoidance assistance control, the apparatus decelerates the own vehicle at a predetermined demanded deceleration rate by means of automatic braking which automatically activates a brake apparatus, to thereby avoid collision with the obstacle.

When the collision avoidance assistance control is performed, the following problems occur if the demanded deceleration rate used in the automatic braking is set to a fixed deceleration rate irrespective of the distance between the own vehicle and the obstacle and irrespective of the relative speed between the own vehicle and the obstacle. For example, in the case where the demanded deceleration rate is set to a fixed large deceleration rate in order to avoid collision with an obstacle without fail, the own vehicle decelerates at an excessively large deceleration rate when the automatic braking is performed in a state in which the distance between the own vehicle and the obstacle is relatively long or a state in which the relative speed in relation to the obstacle is relatively low. As a result, the own vehicle stops an unnecessarily long distance away from the obstacle, and the driver feels that the automatic braking is unnecessary (hereinafter referred to as “the driver's feeling of unnecessariness”).

A conceivable method for reducing such driver's feeling of unnecessariness is to set the demanded deceleration rate used in the automatic braking to a small deceleration rate. However, setting the demanded deceleration rate to a fixed small deceleration rate brings about a possibility that collision between the own vehicle and the obstacle cannot be avoided without fail, for example, when the automatic braking is performed in a state in which the distance between the own vehicle and the obstacle is relatively short or a state in which the relative speed in relation to the obstacle is relatively high.

### SUMMARY OF THE INVENTION

The present disclosure discloses a technique which has been achieved so as to solve the above-described problem. Namely, an object of the technique is to enable proper setting of a demanded deceleration rate for automatic braking when collision avoidance assistance control is performed.

A driving assistance apparatus (1) of the present disclosure comprises:

an object information obtaining section (30) which obtains a piece of object information including a distance (Dr) between a vehicle (SV) and an object present ahead of the vehicle (SV) and a relative speed (Vr) between the vehicle (SV) and the object;

an operation amount obtaining section (23) which obtains, as an operation amount, an amount by which an accelerator pedal is operated by an occupant of the vehicle (SV); and

a control section (10) which predicts whether or not the vehicle (SV) will collide with the object on the basis of the object information obtained by the object information obtaining section (30) and executes collision avoidance assistance control in the case where the control section predicts that the vehicle (SV) will collide with the object and an execution condition becomes satisfied as a result of the operation amount obtained by the operation amount obtaining section (23) having become equal to or greater than a predetermined operation amount, wherein, in the collision avoidance assistance control, the control section decelerates the vehicle (SV) at a predetermined demanded deceleration rate (Gp) by means of automatic braking which automatically activates a brake apparatus (71) of the vehicle (SV),

wherein the control section (10) sets the demanded deceleration rate (Gp) on the basis of the distance (Dr) and the relative speed (Vr) which are obtained by the object information obtaining section (30) when the execution condition becomes satisfied.

A driving assistance method of the present disclosure comprises:

obtaining a piece of object information including a distance (Dr) between a vehicle (SV) and an object present ahead of the vehicle (SV) and a relative speed (Vr) between the vehicle (SV) and the object;

obtaining, as an operation amount, an amount by which an accelerator pedal is operated by an occupant of the vehicle (SV);

predicting whether or not the vehicle (SV) collides with the object on the basis of the obtained object information;

executing collision avoidance assistance control in the case where the vehicle (SV) is predicted to collide with the object and an execution condition becomes satisfied as a result of the obtained operation amount having become equal to or greater than a predetermined operation amount, the collision avoidance assistance control comprising decelerating the vehicle (SV) at a predetermined demanded deceleration rate (Gp) by means of automatic braking which automatically activates a brake apparatus (71) of the vehicle (SV); and

setting the demanded deceleration rate (Gp) on the basis of the distance (Dr) and the relative speed (Vr) which are obtained when the execution condition becomes satisfied.

A program of the present disclosure causes a computer (10) of a driving assistance apparatus (1) to execute a process comprising:

obtaining a piece of object information including a distance (Dr) between a vehicle (SV) and an object present ahead of the vehicle (SV) and a relative speed (Vr) between the vehicle (SV) and the object;

obtaining, as an operation amount, an amount by which an accelerator pedal is operated by an occupant of the vehicle (SV);

predicting whether or not the vehicle (SV) collides with the object on the basis of the obtained object information;

executing collision avoidance assistance control in the case where the vehicle (SV) is predicted to collide with the object and an execution condition becomes satisfied as a result of the obtained operation amount having become equal to or greater than a predetermined operation amount, the collision avoidance assistance control comprising decelerating the vehicle (SV) at a predetermined demanded deceleration rate (Gp) by means of automatic braking which automatically activates a brake apparatus (71) of the vehicle (SV); and

setting the demanded deceleration rate (Gp) on the basis of the distance (Dr) and the relative speed (Vr) which are obtained when the execution condition becomes satisfied.

In the driving assistance apparatus, the driving assistance method, and the program of the present disclosure, the demanded deceleration rate (Gp) used in the automatic braking is set on the basis of the distance (Dr) between the vehicle (SV) and the obstacle and the relative speed (Vr) in relation to the obstacle obtained when the execution condition of the automatic braking becomes satisfied. As a result, when the collision avoidance assistance control is executed, the automatic braking can be performed at an appropriate demanded deceleration rate (Gp) corresponding to the distance (Dr) between the vehicle (SV) and the obstacle and the relative speed (Vr) in relation to the obstacle.

In the driving assistance apparatus of the present disclosure, the control section (10) may set the demanded deceleration rate (Gp) in such a manner that the shorter the distance (Dr) and the higher the relative speed (Vr), the larger the deceleration rate to which the demanded deceleration rate (Gp) is set, wherein the distance (Dr) and the relative speed (Vr) are those obtained by the object information obtaining section (30) when the execution condition becomes satisfied.

In this case, the shorter the distance (Dr) and the higher the relative speed (Vr), the larger the deceleration rate to which the demanded deceleration rate (Gp) used in the automatic braking can be set. Therefore, the vehicle (SV) can avoid collision with the obstacle without fail.

In the driving assistance apparatus of the present disclosure, the control section (10) may set the demanded deceleration rate (Gp) in such a manner that the longer the distance (Dr) and the lower the relative speed (Vr), the smaller the deceleration rate to which the demanded deceleration rate (Gp) is set, wherein the distance (Dr) and the relative speed (Vr) are those obtained by the object information obtaining section (30) when the execution condition becomes satisfied.

In this case, the longer the distance (Dr) and the lower the relative speed (Vr), the smaller the deceleration rate to which the demanded deceleration rate (Gp) used in the automatic braking can be set. Therefore, it is possible to prevent the vehicle (SV) from stopping an unnecessarily long distance away from the obstacle, whereby the driver's feeling of unnecessariness can be reduced without fail.

In the above description, in order to facilitate understanding of the present invention, the constituent elements of the invention corresponding to those of an embodiment of the invention which will be described later are accompanied by parenthesized reference numerals which are used in the embodiment; however, the constituent elements of the invention are not limited to those in the embodiment defined by the reference numerals.

### BRIEF DESCRIPTION OF THE DRAWINGS

FIG. 1 is a schematic overall diagram of a driving assistance apparatus according to an embodiment;

FIG. 2 is a schematic diagram showing an example of a demanded deceleration rate map employed in the embodiment;

FIGS. 3(A) and 3(B) are timing charts used for describing a specific flow of PCS control according to the embodiment; and

FIG. 4 is a flowchart used for describing a routine for the PCS control according to the embodiment.

### DESCRIPTION OF THE PREFERRED EMBODIMENT

A driving assistance apparatus, a driving assistance method, and a program according to an embodiment will now be described with reference to the drawings.

### [Overall Configuration]

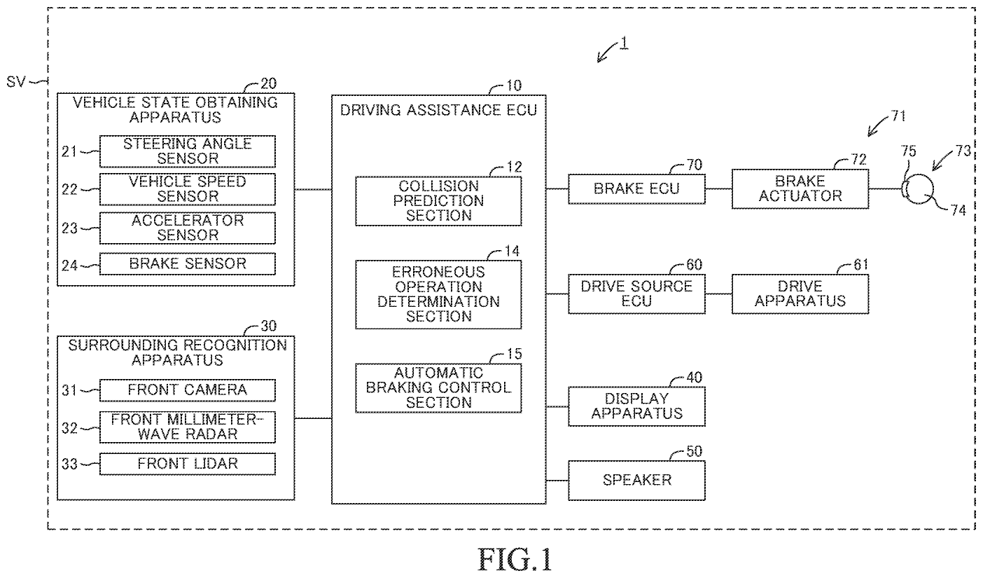

FIG. 1 is a schematic overall diagram of a driving assistance apparatus 1 according to the present embodiment. The driving assistance apparatus 1 is mounted on a vehicle SV. When the vehicle SV must be distinguished from other vehicles, the vehicle SV will be referred to as the own vehicle. The driving assistance apparatus 1 includes a driving assistance ECU 10, a drive source ECU 60, and a brake ECU 70.

These ECUs 10, 60, and 70 are electronic control units each including a microcomputer as a main component and are connected to one another through an unillustrated CAN (controller area network) in such a manner that they can exchange pieces of information with one another through transmission and reception of the pieces of information. The microcomputer includes a CPU, a ROM, a RAM, an interface, etc. The CPU realizes various functions by executing instructions (programs, routines) stored in the ROM. Some or all of the ECUs 10, 60, and 70 may be integrated into a single ECU.

The driving assistance ECU 10 is a controller which plays a central role in assisting a driver to drive the vehicle and executes collision avoidance assistance control. The collision avoidance assistance control calls driver's attention (warns the driver) upon detection of an obstacle which is present ahead of the own vehicle SV during a travel and the own vehicle SV is highly likely to collide with the obstacle. When the possibility of collision increases further, the collision avoidance assistance control executes automatic braking, thereby avoiding collision between the own vehicle SV and the obstacle. In general, the collision avoidance assistance control is called PCS control (pre-crush safety control). Therefore, in the following description, the collision avoidance assistance control will be referred to as PCS control.

A vehicle state obtaining apparatus 20, a surrounding recognition apparatus 30, a display 40, a speaker 50, etc. are connected to the driving assistance ECU 10.

The vehicle state obtaining apparatus 20 is a group of sensors for obtaining the state of the vehicle SV. Specifically, the vehicle state obtaining apparatus 20 includes a steering angle sensor 21, a vehicle speed sensor 22, an accelerator sensor 23, a brake sensor 24, etc.

The steering angle sensor 21 detects the steering angle of an unillustrated steering wheel (or an unillustrated steering shaft). The vehicle speed sensor 22 detects the travel speed of the vehicle SV (vehicle speed V). The vehicle speed sensor 22 may be a wheel speed sensor. The accelerator sensor 23 detects the operation amount of an unillustrated accelerator pedal. The brake sensor 24 detects the operation amount of an unillustrated brake pedal. The pieces of information representing the state of the vehicle SV and obtained by the vehicle state obtaining apparatus 20 are transmitted to the driving assistance ECU 10. Notably, the accelerator sensor 23 may be connected to the drive source ECU 60, and the brake sensor 24 may be connected to the brake ECU 70.

The surrounding recognition apparatus 30 is a group of sensors for recognizing objects around the vehicle SV and outputting pieces of object information relating to the objects. Specifically, the surrounding recognition apparatus 30 includes a front camera 31, a front millimeter-wave radar 32, a front LiDAR 33, etc. The pieces of object information relating to the objects around the vehicle SV and obtained by the surrounding recognition apparatus 30 are transmitted to the driving assistance ECU 10 at predetermined intervals.

The front camera 31 is disposed, for example, on an upper portion of a front windshield glass of the vehicle SV. The front camera 31 is, for example, a stereo camera or a monocular camera, and a digital camera including an imaging device such as CMOS or CCD can be used. The front camera 31 captures an image of a scene ahead of the vehicle SV and processes data of the captured image, thereby obtaining a piece of information relating to an object present ahead of the vehicle SV (hereinafter referred to as the “front object information” or simply as the “object information”). The object information represents the type of an obstacle detected ahead of the vehicle SV, the distance between the vehicle SV and the obstacle, the relative speed between the vehicle SV and the obstacle, etc. The type of the obstacle may be recognized, for example, through machine learning such as pattern matching.

The front millimeter-wave radar 32 is provided, for example, at a central position (in the vehicle width direction) of a front end portion of the vehicle SV, and detects an obstacle present in a region in front of the vehicle SV. The front millimeter-wave radar 32 radiates a radio wave in the millimeter wave band (hereinafter referred to as “millimeter wave”), and receives a millimeter wave (i.e., reflection wave) reflected by obstacles (for example, other vehicles, pedestrians, buildings, etc.) present in a region to which the millimeter wave is radiated. The front millimeter-wave radar 32 obtains the distance between the vehicle SV and the obstacle, the relative speed between the vehicle SV and the obstacle, the position (direction) of the obstacle in relation to the vehicle SV, etc. on the basis of the phase difference between the transmitted millimeter wave and the received reflection wave, the level of attenuation of the reflection wave, the time elapsed until the front millimeter-wave radar 32 received the reflection wave after having transmitted the millimeter wave, etc.

The front LiDAR 33 is provided, for example, at the central position (in the vehicle width direction) of the front end portion of the vehicle SV. The front LiDAR 33 emits pulsed laser light whose wavelength is shorter than the millimeter wave toward a plurality of directions successively through scanning operation, and receives reflection light from an object, thereby obtaining the front object information. The object information represents, for example, the shape of an obstacle detected ahead of the vehicle SV, the distance between the vehicle SV and the obstacle, the relative speed between the vehicle SV and the obstacle.

Upon reception of an alert screen display instruction from the driving assistance ECU 10, the display apparatus 40 displays an alert screen. The alert screen includes an image for calling driver's attention. An example of the display apparatus 40 is a multi-information display or a head-up display provided in front of the driver's seat of the vehicle SV. Upon reception of a warning sound output instruction from the driving assistance ECU 10, the speaker 50 outputs a warning sound for calling driver's attention.

A drive apparatus 61 is mounted on the vehicle SV. The drive apparatus 61 generates drive power which is transmitted to drive wheels of the vehicle SV. The drive apparatus 61 is, for example, an electric motor or an engine. The vehicle SV may be any of an engine vehicle, a hybrid vehicle (HEV), a plug-in hybrid vehicle (PHEV), a fuel cell vehicle (FCEV), and a battery electric vehicle (BEV).

The drive source ECU 60 is connected to the drive apparatus 61. The drive source ECU 60 sets a driver demanded torque on the basis of the accelerator pedal operation amount detected by the accelerator sensor 23, etc., and controls the operation of the drive apparatus 61 such that the drive apparatus 61 outputs the driver demanded torque. Also, in the case where the own vehicle SV is determined during a travel to have a possibility of collision with an obstacle present ahead of the vehicle SV, and the driving assistance ECU 10 executes the PCS control, the drive source ECU 60 controls the operation of the drive apparatus 61 so as to limit the output torque of the drive apparatus 61. Also, in the case where the driving assistance ECU 10 executes the PCS control, the drive source ECU 60 controls the drive apparatus 61 such that, even when the driver operates the accelerator (accelerator pedal), the drive apparatus 61 does not accept the driver's accelerator pedal operation.

A brake apparatus 71 is mounted on the vehicle SV. The brake apparatus 71 is, for example, a disc-type brake apparatus and applies braking forces to the wheels of the vehicle SV. The brake apparatus 71 includes a brake actuator 72. The brake actuator 72 is provided in a hydraulic circuit between an unillustrated master cylinder, which pressurizes hydraulic fluid in accordance with a depressing force applied to the brake pedal, and friction brake mechanisms 73 provided for left and right front wheels and left and right rear wheels. Each friction brake mechanism 73 includes a brake disc 74 fixed to the corresponding wheel and a brake caliper 75 fixed to a vehicle body. The brake actuator 72 adjusts the pressure of the hydraulic fluid supplied to a wheel cylinder incorporated into the brake caliper 75. By the pressure of the hydraulic fluid, the wheel cylinder is operated, so that brake pads are pressed against the brake disc 74, thereby generating a frictional braking force. Notably, the brake apparatus 71 is not limited to the disc-type brake apparatus, and may be any of other brake apparatuses which apply braking forces to the wheels of the vehicle SV, such as a drum-type brake apparatus.

The brake ECU 70 is connected to the brake actuator 72. The brake ECU 70 sets a driver demanded deceleration rate Gd on the basis of the operation amount of the brake pedal detected by the brake sensor 24 and controls the operation of the brake actuator 72 such the vehicle SV decelerates at the driver demanded deceleration rate Gd. Also, in the case where the brake pedal is operated by the driver in a state in which the brake ECU 70 has received an PCS brake instruction from the driving assistance ECU 10, the brake ECU 70 employs, as a final demanded deceleration rate, a demanded deceleration rate which is selected from the driver demanded deceleration rate Gd and a PCS demanded deceleration rate Gp (which will be described later) and which has a larger absolute value. The brake ECU 70 controls the operation of the brake actuator 72 such that the vehicle SV decelerates at the final demanded deceleration rate. Namely, the brake ECU 70 performs brake override.

### [Pcs Control]

Next, the PCS control will be described. When attention is paid to functions of the driving assistance ECU 10, the driving assistance ECU 10 has a collision prediction section 12, an erroneous operation determination section 14, and an automatic braking control section 15 as functional elements. These functional elements will be described under an assumption that they are contained in the driving assistance ECU 10, which is a single hardware unit. However, some functional elements may be provided in an ECU provided separately from the driving assistance ECU 10.

The collision prediction section 12 extracts, as an obstacle, an object which may collide with the own vehicle SV, among objects present ahead of the vehicle SV, on the basis of the front object information obtained by the surrounding recognition apparatus 30, and computes the value of a distance Dr between the own vehicle SV and the extracted obstacle.

Also, on the basis of the distance Dr between the own vehicle SV and the obstacle, the collision prediction section 12 predicts whether or not the own vehicle SV will collide with the obstacle present ahead of the vehicle SV when an erroneous operation occurs because the driver mistakes the accelerator pedal for the brake pedal (hereinafter referred to as an “erroneous accelerator pedal operation”). Specifically, a threshold distance Dth is stored in the ROM of the driving assistance ECU 10. The threshold distance Dth is a distance which serves as an index value indicating a predicted possibility that the own vehicle SV collides with the obstacle when an erroneous accelerator pedal operation occurs. By comparing the threshold distance Dth read from the ROM and the distance Dr computed repeatedly, the collision prediction section 12 predicts whether or not the own vehicle SV will collide with the obstacle present ahead of the vehicle SV when an erroneous accelerator pedal operation occurs.

When the value of the distance Dr between the own vehicle SV and the obstacle has decreased to the threshold distance Dth, the collision prediction section 12 determines that the collision possibility level has reached a level corresponding to a pre-collision stage in which the own vehicle SV may collide with the obstacle when an erroneous accelerator pedal operation occurs. In the case where the collision possibility level is determined to have reached the level corresponding to the pre-collision stage and an erroneous accelerator pedal operation is determined to have been performed, the automatic braking control section 15 executes automatic braking. Notably, the method for collision prediction is not limited to a method in which the distance Dr and the threshold distance Dth are compared with each other, and collision can be predicted on the basis of a predicted collision time TTC. The predicted collision time TTC is obtained by dividing the distance Dr between the own vehicle SV and the obstacle at a certain point in time by the relative speed Vr at the certain point in time (TTC=Dr/Vr). In the case where collision prediction is performed on the basis of the predicted collision time TTC, the predicted collision time TTC is compared with a threshold time which serves as an index value indicating a predicted possibility that the own vehicle SV collides with the obstacle. When the predicted collision time TTC has become equal to or less than the threshold time, the collision prediction section 12 may determine that the collision possibility level has reached the level corresponding to the pre-collision stage in which the own vehicle SV may collide with the obstacle when an erroneous accelerator pedal operation occurs.

In the case where the collision prediction section 12 has determined that the collision possibility level has reached the level corresponding to the pre-collision stage, the erroneous operation determination section 14 determines whether or not the driver has mistaken the accelerator pedal for the brake pedal and has depressed the accelerator pedal (i.e., whether or not the driver has performed an erroneous accelerator pedal operation). For example, it is considered that, in the case where the driver recognizes an obstacle present ahead of the vehicle SV and performs an avoidance operation for avoiding collision with the obstacle, the driver may gently accelerate the vehicle SV while performing a steering operation. Also, it is considered that, in a situation in which the own vehicle SV is close to the obstacle present ahead of the vehicle SV, in general, the driver does not operate the accelerator (the accelerator pedal) by a large amount. In the case where a large accelerator pedal operation amount is detected in such a situation, that accelerator pedal operation can be estimated to be an erroneous accelerator pedal operation.

In the case where an accelerator pedal operation amount AP detected by the accelerator sensor 23 is equal to or greater than a predetermined operation amount threshold APv when the collision prediction section 12 has determined that the collision possibility level has reached the level corresponding to the pre-collision stage, the erroneous operation determination section 14 determines that the driver's accelerator pedal operation has occurred due to an erroneous operation. Notably, the determination as to whether or not the driver's accelerator pedal operation is an erroneous operation may be performed by combining the accelerator pedal operation amount with the states of other operations such as steering operation, operation of a turn signal lever, etc.

In the case where the collision prediction section 12 has determined that the collision possibility level has reached the level corresponding to the pre-collision stage and the driver's accelerator pedal operation has been determined to have occurred due to an erroneous operation, the automatic braking control section 15 determines that a condition for executing automatic braking (hereinafter referred to as the “automatic braking execution condition”) has become satisfied and transmits a PCS brake instruction to the brake ECU 70. This PCS brake instruction includes a piece of information representing a PCS demanded deceleration rate Gp.

Upon reception of the PCS brake instruction, the brake ECU 70 controls the operation of the brake actuator 72 such that the vehicle SV decelerates at the PCS demanded deceleration rate Gp. As a result, it is possible to generate frictional braking forces applied to the left and right front wheels and the left and right rear wheels, without requiring the driver to operate the brake pedal, thereby forcedly decelerating the vehicle SV. As described above, in response to the PCS brake instruction, a control for generating frictional braking forces applied to the left and right front wheels and the left and right rear wheels, thereby decelerating the own vehicle SV is performed. Such control is automatic braking.

During a period during which automatic braking is being executed (hereinafter referred to as the “automatic braking execution period”), the automatic braking control section 15 transmits to the drive source ECU 60 a drive power limiting instruction for limiting the output torque of the drive apparatus 61 (for example, reducing the output torque to zero). Accordingly, even when the driver operates the accelerator pedal in the automatic braking execution period, a driver demanded torque is not accepted, and the vehicle SV does not accelerate in accordance with the accelerator pedal operation.

The automatic braking control section 15 determines, through monitoring, whether or not, as a result of the automatic braking, the own vehicle SV has entered a state in which the own vehicle SV can avoid collision. Specifically, the automatic braking control section 15 determines that the own vehicle SV has entered a state in which the own vehicle SV can avoid collision and ends the transmission of the PCS brake instruction in any of the following cases:

the case where the obstacle has moved away from the own vehicle SV;

the case where, due to the automatic braking, the own vehicle SV has stopped before reaching the obstacle; and

the case where the predicted collision time TTC is used and the predicted collision time TTC has become larger than a predetermined end threshold time TTCb (>TTCa).

As a result, the automatic braking ends, and simultaneously, the PCS control also ends.

Incidentally, the following problems occur when the PCS demanded deceleration rate Gp used when the automatic braking is executed is fixed to a constant deceleration rate irrespective of the distance Dr between the own vehicle SV and the obstacle and the relative speed Vr in relation to the obstacle. For example, if the PCS demanded deceleration rate Gp is set to a constant large deceleration rate in order to avoid collision with the obstacle without fail, the own vehicle SV is decelerated at an excessively large deceleration rate when the automatic braking is executed in a state in which the distance Dr between the own vehicle SV and the obstacle is relatively long or a state in which the relative speed Vr in relation to the obstacle is relatively low. Therefore, the own vehicle SV stops an unnecessarily long distance away from the obstacle, and the driver feels that the automatic braking is unnecessary. Meanwhile, if the PCS demanded deceleration rate Gp is set to a constant small deceleration rate in order to reduce such driver's feeling of unnecessariness, it becomes impossible to avoid collision with the obstacle without fail when the automatic braking is executed, for example, in a state in which the distance Dr between the own vehicle SV and the obstacle is relatively short or a state in which the relative speed Vr is relatively high.

In view of the above, in the present embodiment, these problems are solved by setting the PCS demanded deceleration rate Gp to an optimum value corresponding to the distance Dr between the own vehicle SV and the obstacle and the relative speed Vr between the own vehicle SV and the obstacle at the time when the automatic braking execution condition has become satisfied. A specific process of setting the PCS demanded deceleration rate Gp will now be described.

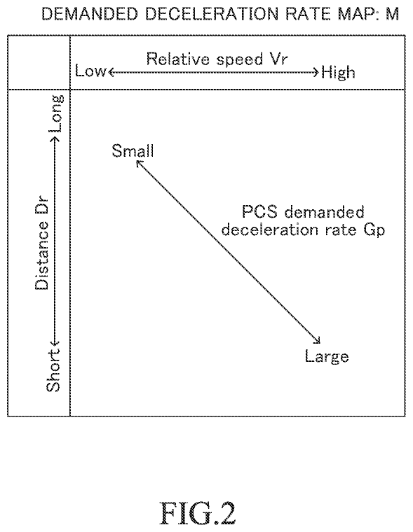

FIG. 2 is a schematic diagram showing an example of a demanded deceleration rate map M employed in the present embodiment. The demanded deceleration rate map M is prepared, for example, by performing experiments, simulation, etc. in the stage of designing and developing the vehicle SV and is stored in the ROM of the driving assistance ECU 10 beforehand. In this demanded deceleration rate map M, the PCS demanded deceleration rate Gp (absolute value) is set such that it changes in accordance with the distance Dr between the own vehicle SV and the obstacle and the relative speed Vr between the own vehicle SV and the obstacle.

In the demanded deceleration rate map M, the PCS demanded deceleration rate Gp is set such that the shorter the distance Dr and the higher the relative speed Vr, the larger the deceleration rate to which the PCS demanded deceleration rate Gp is set, and the longer the distance Dr and the lower the relative speed Vr, the smaller the deceleration rate to which the PCS demanded deceleration rate Gp is set. Also, in the demanded deceleration rate map M, even in the case where the distance Dr is short, the PCS demanded deceleration rate Gp is set to a relatively small deceleration rate when the relative speed Vr is low, and even in the case where the distance Dr is long, the PCS demanded deceleration rate Gp is set to a relatively large deceleration rate when the relative speed Vr is high.

When the automatic braking execution condition has become satisfied, the automatic braking control section 15 determines the PCS demanded deceleration rate Gp corresponding to the distance Dr and the relative speed Vr by referring to the demanded deceleration rate map M on the basis of the distance Dr between the own vehicle SV and the obstacle and the relative speed Vr of the own vehicle SV and the obstacle at that time. Subsequently, the automatic braking control section 15 outputs a PCS brake instruction, including the determined PCS demanded deceleration rate Gp, to the brake ECU 70. Upon reception of the PCS brake instruction, the brake ECU 70 controls the operation of the brake actuator 72 such that the vehicle SV decelerates at the PCS demanded deceleration rate Gp.

Since, as described above, the PCS demanded deceleration rate Gp used in the automatic braking is not set to a constant deceleration rate but is set to an appropriate value corresponding to the distance Dr between the own vehicle SV and the obstacle and the relative speed Vr between the own vehicle SV and the obstacle, in the case where the distance Dr is long and the relative speed Vr is low, the own vehicle SV decelerates at a small PCS demanded deceleration rate Gp. As a result, it becomes possible to prevent occurrence of the problem that an excessive large deceleration is produced in the own vehicle SV and the problem that the own vehicle SV stops an unnecessarily long distance away from the obstacle, whereby the driver's feeling of unnecessariness can be reduced without fail. Also, in the case where the distance Dr is short and the relative speed Vr is high, it becomes possible to avoid collision with the obstacle without fail by decelerating the own vehicle SV at a large PCS demanded deceleration rate Gp.

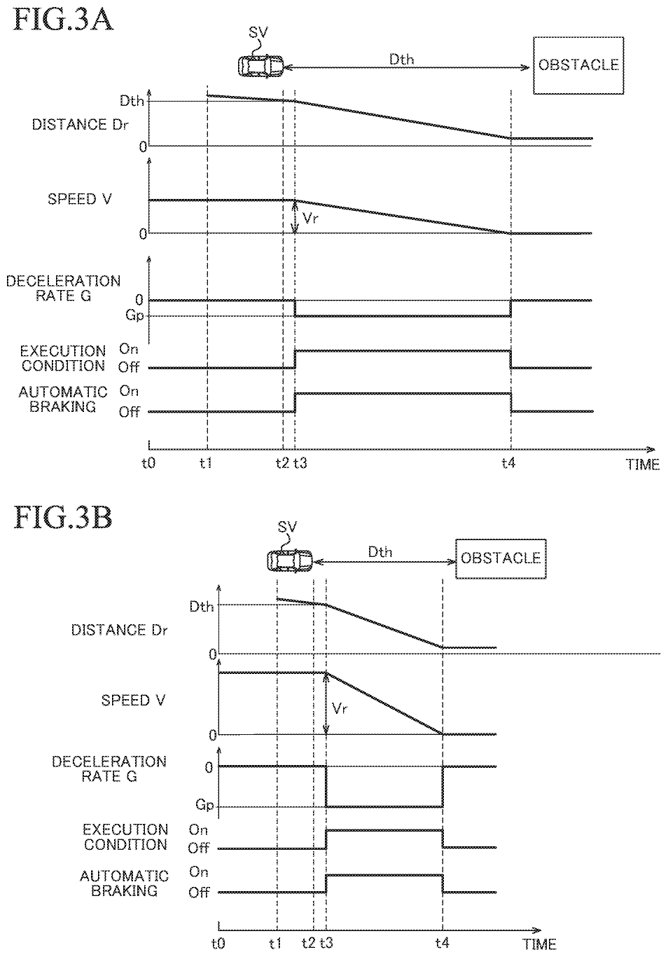

Next, a specific flow of the PCS control will be described on the basis of timing charts shown in FIGS. 3(A) and 3(B). FIG. 3(A) shows the case where the automatic braking is executed in a state in which the distance Dr between the own vehicle SV and the obstacle is relatively long and the relative speed Vr is relatively low, and FIG. 3(B) shows the case where the automatic braking is executed in a state in which the distance Dr between the own vehicle SV and the obstacle is relatively short and the relative speed Vr is relatively high.

At time t0 shown in FIGS. 3(A) and 3(B), the vehicle SV is travelling at a predetermined speed. At time t1, the driving assistance ECU 10 detects, on the basis of the front object information obtained by the surrounding recognition apparatus 30, an obstacle which may collide with the vehicle SV. Upon detection of the obstacle, the driving assistance ECU 10 starts computation of the distance Dr between the own vehicle SV and the obstacle.

When the value of the distance Dr decreases to the threshold distance Dth at time t2, the driving assistance ECU 10 determines whether or not the driver has performed an erroneous accelerator pedal operation; i.e., has erroneously depressed the accelerator pedal, on the basis of the accelerator pedal operation amount AP detected by the accelerator sensor 23. In the case where the accelerator pedal operation amount AP becomes equal to or grater than the predetermined operation amount threshold APv at time t3, the driving assistance ECU 10 determines that the driver has performed an erroneous accelerator pedal operation, and determines that the automatic braking execution condition has become satisfied.

When the driving assistance ECU 10 determines at time t3 that the automatic braking execution condition has become satisfied, the driving assistance ECU 10 sets the PCS demanded deceleration rate Gp corresponding to the distance Dr between the own vehicle SV and the obstacle and the relative speed Vr between the own vehicle SV and the obstacle by referring to the demanded deceleration rate map M (shown in FIG. 2) on the basis of the distance Dr and the relative speed Vr at that time. Also, the driving assistance ECU 10 starts the automatic braking by outputting the PCS brake instruction, including the set PCS demanded deceleration rate Gp, to the brake ECU 70.

In the case where the driving assistance ECU 10 finds at time t4 after having started the automatic braking that the obstacle has moved away from the own vehicle SV, that the own vehicle SV has stopped before reaching the obstacle, or that the predicted collision time TTC (in the case where the predicted collision time TTC is used) has become greater than the predetermined end threshold time TTCb (>TTCa), the driving assistance ECU 10 determines that the own vehicle SV has entered a state in which the vehicle SV can avoid collision with the obstacle, and ends the automatic braking; i.e., ends the PCS control.

In the present embodiment, the PCS demanded deceleration rate Gp, used in the automatic braking executed over the period between time t3 and time t4, is set to an appropriate deceleration rate corresponding to the distance Dr between the own vehicle SV and the obstacle and the relative speed Vr between the own vehicle SV and the obstacle, at time t3 when the automatic braking execution condition becomes satisfied, by referring to the demanded deceleration rate map M (shown in FIG. 2) on the basis of the distance Dr and the relative speed Vr, which are obtained by the surrounding recognition apparatus 30.

Namely, in the case where, as shown in FIG. 3(A), the distance Dr between the own vehicle SV and the obstacle is long and the relative speed Vr between the own vehicle SV and the obstacle is low at time t3 when the automatic braking execution condition becomes satisfied, the PCS demanded deceleration rate Gp used in the automatic braking is set to a small deceleration rate. As a result, it is possible to prevent generation of excessively large deceleration in the own vehicle SV over the period between time t3 and time t4. Furthermore, it becomes possible to effectively prevent the own vehicle SV from stopping an unnecessarily long distance away from the obstacle. Therefore, it becomes possible to reduce the driver's feeling of unnecessariness without fail.

Meanwhile, in the case where, as shown in FIG. 3(B), the distance Dr between the own vehicle SV and the obstacle is short and the relative speed Vr between the own vehicle SV and the obstacle is high at time t3 when the automatic braking execution condition becomes satisfied, the PCS demanded deceleration rate Gp used in the automatic braking is set to a large deceleration rate. As a result, it is possible to decelerate the own vehicle SV at a large deceleration rate over the period between time t3 and time t4, and therefore, the own vehicle SV can avoid collision with the obstacle without fail.

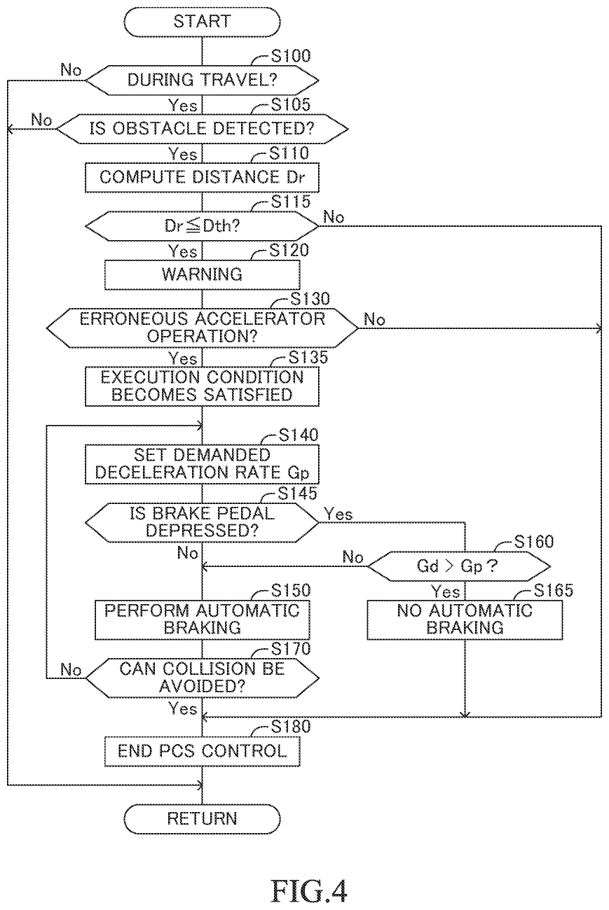

Next, a routine for PCS control executed by the driving assistance ECU 10 will be described with reference to a flowchart shown in FIG. 4.

In step S100, the driving assistance ECU 10 determines whether or not the own vehicle SV is travelling on the basis of the vehicle speed detected by the vehicle speed sensor 22. In the case where the own vehicle SV is travelling (Yes), the driving assistance ECU 10 proceeds to step S105. Meanwhile, in the case where the own vehicle SV is not travelling (No); namely, the own vehicle SV is stopped, the driving assistance ECU 10 ends the current execution of the present routine.

In step S105, the driving assistance ECU 10 determines whether or not an obstacle is detected ahead of the own vehicle SV on the basis of the front object information obtained by the surrounding recognition apparatus 30. In the case where an obstacle is detected ahead of the own vehicle SV (Yes), the driving assistance ECU 10 proceeds to step S110. Meanwhile, in the case where no obstacle is detected ahead of the own vehicle SV (No), the driving assistance ECU 10 ends the current execution of the present routine.

In step S110, the driving assistance ECU 10 computes the distance Dr between the own vehicle SV and the obstacle on the basis of the front object information obtained by the surrounding recognition apparatus 30. Subsequently, the driving assistance ECU 10 proceeds to step S115. Notably, in the case where the PSC control is executed on the basis of the predicted collision time TTC, the driving assistance ECU 10 computes the predicted collision time TTC in step S110.

In step S115, the driving assistance ECU 10 determines whether or not the distance Dr has decreased to the threshold distance Dth. In the case where the distance Dr has decreased to the threshold distance Dth (Yes), the driving assistance ECU 10 determines that the collision possibility level has reached the level corresponding to the pre-collision stage and proceeds to step S120. Meanwhile, in the case where the distance Dr has not yet decreased to the threshold distance Dth (No), the driving assistance ECU 10 proceeds to step S180. Notably, in the case where the PSC control is executed on the basis of the predicted collision time TTC, the driving assistance ECU 10 determines in step S115 whether or not the predicted collision time TTC has become equal to or shorter than a threshold time, and proceeds to step S120 when the result of the determination is affirmative (Yes) or to step S180 when the result of the determination is negative (No).

In step 120, the driving assistance ECU 10 warns the driver by causing the display 40 to display an alert screen and/or causing the speaker 50 to produce a warning sound. Subsequently, the driving assistance ECU 10 proceeds to step S130.

In step S130, the driving assistance ECU 10 determines whether or not an erroneous accelerator pedal operation has been performed (the driver has mistaken the accelerator pedal for the brake pedal and has depressed the accelerator pedal) by determining whether or not the accelerator pedal operation amount AP detected by the accelerator sensor 23 has become equal to or greater than the predetermined operation amount threshold APv. In the case where an erroneous accelerator pedal operation has been performed (Yes), the driving assistance ECU 10 proceeds to step S135. Meanwhile, In the case where no erroneous accelerator pedal operation has been performed (No), the driving assistance ECU 10 proceeds to step S180.

In step S135, the driving assistance ECU 10 determines that the automatic braking execution condition has become satisfied. Subsequently, in step S140, the driving assistance ECU 10 determines the PCS demanded deceleration rate Gp corresponding to the distance Dr between the own vehicle SV and the obstacle and the relative speed Vr between the own vehicle SV and the obstacle by referring to the demanded deceleration rate map M (FIG. 2) on the basis of the distance Dr and the relative speed Vr, which are obtained by the surrounding recognition apparatus 30 when the driving assistance ECU 10 has determined that the automatic braking execution condition has become satisfied. Subsequently, the driving assistance ECU 10 proceeds to step S145.

In step S145, the driving assistance ECU 10 determines whether or not the brake pedal has been depressed by the driver (after having released the accelerator pedal). In the case where the brake pedal has not been depressed (No), the driving assistance ECU 10 proceeds to step S150. Meanwhile, in the case where the brake pedal has been depressed (Yes), the driving assistance ECU 10 proceeds to step S160.

In step S160, the driving assistance ECU 10 determines whether or not the driver demanded deceleration rate Gd (absolute value) corresponding to the operation amount of the brake pedal is greater than the PCS demanded deceleration rate Gp (absolute value) set in step S140. In the case where the driver demanded deceleration rate Gd is equal to or less than the PCS demanded deceleration rate Gp (No), the driving assistance ECU 10 proceeds to step S150. Meanwhile, in the case where the driver demanded deceleration rate Gd is greater than the PCS demanded deceleration rate Gp (Yes), the driving assistance ECU 10 proceeds to step S165 and determines not to execute the automatic braking. In this case, the brake ECU 70 controls the operation of the brake actuator 72 so as to decelerate the own vehicle SV at the driver demanded deceleration rate Gd.

In step S150, the driving assistance ECU 10 executes the automatic braking by outputting a PCS brake instruction, including the PCS demanded deceleration rate Gp set in step S145, to the brake ECU 70. As a result, the brake ECU 70 controls the operation of the brake actuator 72 so as to decelerate the own vehicle SV at the PCS demanded deceleration rate Gp.

In step S170, the driving assistance ECU 10 determines whether or not the own vehicle SV has entered a state in which the own vehicle SV can avoid collision with the obstacle. In the case where the obstacle has moved away from the own vehicle SV, the case where the own vehicle SV has stopped before reaching the obstacle, or in the case where the predicted collision time TTC (when the predicted collision time TTC is used) has become greater than the predetermined end threshold time TTCb (>TTCa), the driving assistance ECU 10 determines that the own vehicle SV has entered a state in which the own vehicle SV can avoid collision with the obstacle (Yes) and proceeds to step S180. Meanwhile, in the case where the driving assistance ECU 10 determines that the own vehicle SV has not yet entered the state in which the own vehicle SV can avoid collision with the obstacle (No), the driving assistance ECU 10 returns to step S140.

In step S180, the driving assistance ECU 10 ends the PCS control and then ends the current execution of the present routine. After that, the driving assistance ECU 10 repeatedly executes the processes of steps S100 to S180 during the travel of the vehicle SV.

In the present embodiment having been described in detail above, in the case where the automatic braking is executed by the PCS control, the driving assistance ECU 10 sets a PCS demanded deceleration rate Gp corresponding to the distance Dr and the relative speed Vr by referring to the demanded deceleration rate map M on the basis of the distance Dr and the relative speed Vr at the time when the automatic braking execution condition has become satisfied. In the demanded deceleration rate map M, the PCS demanded deceleration rate Gp is set such that the shorter the distance Dr and the higher the relative speed Vr, the larger the deceleration rate to which the PCS demanded deceleration rate Gp is set, and the longer the distance Dr and the lower the relative speed Vr, the smaller the deceleration rate to which the PCS demanded deceleration rate Gp is set.

Namely, the driving assistance ECU 10 is configured to set the PCS demanded deceleration rate Gp used in the automatic braking to a small deceleration rate in the case where the distance Dr between the own vehicle SV and the obstacle is long and the relative speed Vr in relation to the obstacle is low when the automatic braking execution condition has become satisfied. As a result, it is possible to prevent generation of excessively large deceleration in the own vehicle SV. Furthermore, it becomes possible to effectively prevent the own vehicle SV from stopping an unnecessarily long distance away from the obstacle. Therefore, it becomes possible to reduce the driver's feeling of unnecessariness without fail. Also, the driving assistance ECU 10 is configured to set the PCS demanded deceleration rate Gp used in the automatic braking to a larger deceleration rate in the case where the distance Dr between the own vehicle SV and the obstacle is short and the relative speed Vr in relation to the obstacle is high when the automatic braking execution condition has become satisfied. As a result, the own vehicle SV can avoid collision with the obstacle without fail.

Although the driving assistance apparatus, the driving assistance method, and the program according to the present embodiment have been described, the present invention is not limited to the above-described embodiment, and various modifications can be made without departing from the object of the present invention.

For example, in the above-described embodiment, the driving assistance apparatus may have a plurality of demanded deceleration rate maps M. In this case, the driving assistance apparatus may be configured to select an optimum map from the plurality of maps in accordance with the type of an obstacle (for example, automobile, bicycle, human, etc.) which may collide with the own vehicle SV. Also, the automatic braking has been described as automatic braking which applies braking forces to the wheels by the brake apparatus 71. However, in the case where an electric motor is mounted on the vehicle SV, the automatic braking may use regenerative braking force generated by the electric motor in addition to the braking forces.

In the above-described embodiment, in the case where collision prediction is performed on the basis of the predicted collision time TTC, it is possible to determine the collision possibility level in two stages. Specifically, the driving assistance apparatus may be configured such that, when the predicted collision time TTC has decreased to a first threshold time TTCw, the driving assistance apparatus determines that the collision possibility level has reached an initial, first level, and, when the predicted collision time TTC has further decreased to a second threshold time TTCa, the driving assistance apparatus determines that the collision possibility level has reached a second level which is higher than the first level in terms of possibility of collision. In this case, the driving assistance apparatus warns the driver when the collision possibility level has reached the first level, and executes automatic braking when the collision possibility level has reached the second level and the driver has enormously operated the accelerator pedal. In this case as well, it is possible to set a PCS demanded deceleration rate Gp corresponding to the distance Dr and the relative speed Vr by referring to the demanded deceleration rate map M on the basis of the distance Dr and the relative speed Vr at the time when the accelerator pedal has been erroneously operated. Therefore, it is possible to achieve the same action and effects as those achieved by the driving assistance apparatus of the above-described embodiment.

What is claimed is:

1. A driving assistance apparatus comprising:
an object information obtaining section which obtains a piece of object information including a distance between a vehicle and an object present ahead of the vehicle and a relative speed between the vehicle and the object;
an operation amount obtaining section which obtains, as an operation amount, an amount by which an accelerator pedal is operated by an occupant of the vehicle; and
a control section which predicts whether or not the vehicle will collide with the object on the basis of the object information obtained by the object information obtaining section and executes collision avoidance assistance control in the case where the control section predicts that the vehicle will collide with the object and an execution condition becomes satisfied as a result of the operation amount obtained by the operation amount obtaining section having become equal to or greater than a predetermined operation amount, wherein, in the collision avoidance assistance control, the control section decelerates the vehicle at a predetermined demanded deceleration rate by means of automatic braking which automatically activates a brake apparatus of the vehicle,
wherein the control section sets the demanded deceleration rate on the basis of the distance and the relative speed which are obtained by the object information obtaining section when the execution condition becomes satisfied.

2. A driving assistance apparatus according to claim 1, wherein the control section sets the demanded deceleration rate in such a manner that the shorter the distance and the higher the relative speed, the larger the deceleration rate to which the demanded deceleration rate is set, wherein the distance and the relative speed are those obtained by the object information obtaining section when the execution condition becomes satisfied.

3. A driving assistance apparatus according to claim 1, wherein the control section sets the demanded deceleration rate in such a manner that the longer the distance and the lower the relative speed, the smaller the deceleration rate to which the demanded deceleration rate is set, wherein the distance and the relative speed are those obtained by the object information obtaining section when the execution condition becomes satisfied.

4. A driving assistance method comprising:
obtaining a piece of object information including a distance between a vehicle and an object present ahead of the vehicle and a relative speed between the vehicle and the object;
obtaining, as an operation amount, an amount by which an accelerator pedal is operated by an occupant of the vehicle;
predicting whether or not the vehicle collides with the object on the basis of the obtained object information;
executing collision avoidance assistance control in the case where the vehicle is predicted to collide with the object and an execution condition becomes satisfied as a result of the obtained operation amount having become equal to or greater than a predetermined operation amount, the collision avoidance assistance control comprising decelerating the vehicle at a predetermined demanded deceleration rate by means of automatic braking which automatically activates a brake apparatus of the vehicle; and
setting the demanded deceleration rate on the basis of the distance and the relative speed which are obtained when the execution condition becomes satisfied.

5. A program which causes a computer of a driving assistance apparatus to execute a process comprising:
obtaining a piece of object information including a distance between a vehicle and an object present ahead of the vehicle and a relative speed between the vehicle and the object;
obtaining, as an operation amount, an amount by which an accelerator pedal is operated by an occupant of the vehicle;
predicting whether or not the vehicle collides with the object on the basis of the obtained object information;
executing collision avoidance assistance control in the case where the vehicle is predicted to collide with the object and an execution condition becomes satisfied as a result of the obtained operation amount having become equal to or greater than a predetermined operation amount, the collision avoidance assistance control comprising decelerating the vehicle at a predetermined demanded deceleration rate by means of automatic braking which automatically activates a brake apparatus of the vehicle; and
setting the demanded deceleration rate on the basis of the distance and the relative speed which are obtained when the execution condition becomes satisfied.
